(19) United States
(12) Patent Application Publication
(10) Pub. No.: US 2025/0138245 A1
(43) Pub. Date: May 1, 2025

(54) OPTICAL SWITCH WITH REDUCED SIZE FIBER ARRAY AND LOW MIRROR TILT ANGLE

(71) Applicant: Lumentum Operations LLC, San Jose, CA (US)

(72) Inventors: Paul Dwight COLBOURNE, Ottawa (CA); Sheldon MCLAUGHLIN, Ottawa (CA)

(21) Appl. No.: 18/609,773

(22) Filed: Mar. 19, 2024

Related U.S. Application Data
(60) Provisional application No. 63/595,103, filed on Nov. 1, 2023.

(51) Int. Cl. G02B 6/35

(52) U.S. Cl. CPC G02B 6/3518

(57) ABSTRACT

An optical switch may include a first array of optical ports, a first array of beam-forming elements, and a first array of beam steering elements. The optical switch may further include a first set of optical elements to cause an area of a projected beam-array field at a plane of the first array of beam-forming elements to be larger than an area of the first array of beam-forming elements. The first set of optical elements may be in a region of optical coupling between the first array of beam-forming elements and the first array of beam steering elements. The optical switch may include a second array of beam steering elements, a second array of beam-forming elements, and a second array of optical ports.

### CROSS-REFERENCE TO RELATED APPLICATION

This patent application claims priority to U.S. Provisional Patent Application No. 63/595,103, filed on Nov. 1, 2023, and entitled “OPTICAL SWITCH WITH REDUCED SIZE FIBER ARRAY AND LOW MIRROR TILT ANGLE.” The disclosure of the prior application is considered part of and is incorporated by reference into this patent application.

### TECHNICAL FIELD

The present disclosure relates generally to an optical switch and to an optical switch with a reduced fiber array size and low mirror tilt angle.

### BACKGROUND

In an optical communication network, optical signals having a plurality of optical channels at individual wavelengths (typically called “wavelength channels”) are transmitted from one location to another, typically through a length of optical fiber. An optical cross-connect is a type of optical switch that allows switching of optical signals from one optical fiber to another.

### SUMMARY

In some implementations, an optical switch includes a first array of optical ports; a first array of beam-forming elements, wherein the first array of optical ports is optically coupled to the first array of beam-forming elements; a first array of beam steering elements, wherein the first array of beam-forming elements is optically coupled to the first array of beam steering elements; a first set of optical elements to cause an area of a projected beam-array field at a plane of the first array of beam-forming elements to be larger than an area of the first array of beam-forming elements, wherein the first set of optical elements is in a region of optical coupling between the first array of beam-forming elements and the first array of beam steering elements; a second array of beam steering elements, wherein the first array of beam steering elements is optically coupled to the second array of beam steering elements; a second array of beam-forming elements, wherein the second array of beam steering elements is optically coupled to the second array of beam-forming elements; and a second array of optical ports, wherein the second array of beam-forming elements is optically coupled to the second array of optical ports.

In some implementations, an optical switch includes a first set of optical elements to cause an area of a projected beam-array field at a plane of a first array of beam-forming elements of the optical device to be larger than an area of the first array of beam-forming elements, wherein the first set of optical elements is in a region of optical coupling between the first array of beam-forming elements and a first array of beam steering elements of the optical device; and a second set of optical elements to cause an area of a projected beam-array field at a plane of a second array of beam-forming elements of the optical device to be larger than an area of the second array of beam-forming elements, wherein the second set of optical elements is in a region of optical coupling between a second array of beam steering elements of the optical device and the second array of beam-forming elements.

In some implementations, an optical device includes an array of optical ports; an array of beam-forming elements optically coupled to the array of optical ports; an array of beam steering elements optically coupled to the array of beam-forming elements; and a set of optical elements to cause a size of a projected beam-array field at a plane of the array of beam-forming elements to be larger than a size of the array of beam-forming elements, wherein the set of optical elements is in a region of optical coupling between the array of beam-forming elements and the array of beam steering elements.

### BRIEF DESCRIPTION OF THE DRAWINGS

FIGS. 1A-1B are diagrams illustrating conventional configurations of high port count optical switches in an unfolded arrangement.

FIG. 2 is a diagram illustrating an example implementation of an optical switch that achieves a reduced beam steering angle requirement and a reduced optical port array and beam-forming element array size, without introducing cross-talk.

FIG. 3 is a diagram of an illustrative example of a projected beam-array field in the context of an optical switch described herein.

FIG. 4 is a diagram illustrating an example implementation of an optical switch that achieves a reduced beam steering angle requirement and a reduced optical port array and beam-forming element array size.

FIG. 5 is a diagram illustrating an example implementation of an optical switch that achieves a reduced beam steering angle requirement.

### DETAILED DESCRIPTION

The following detailed description of example implementations refers to the accompanying drawings. The same reference numbers in different drawings may identify the same or similar elements.

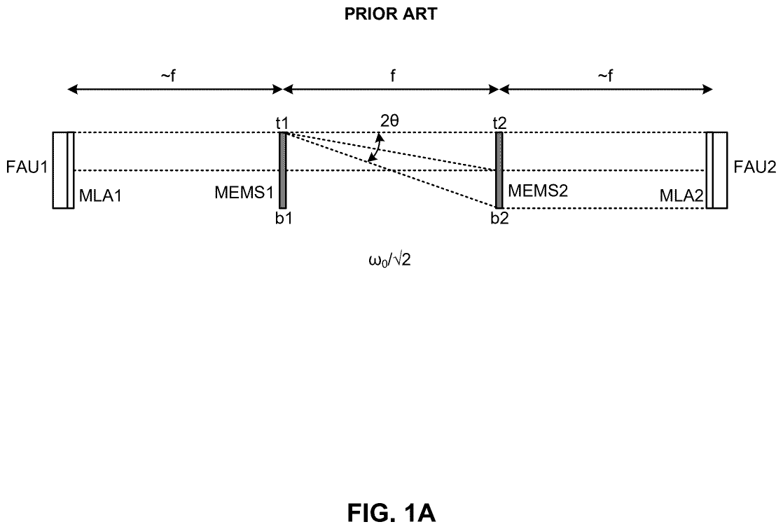

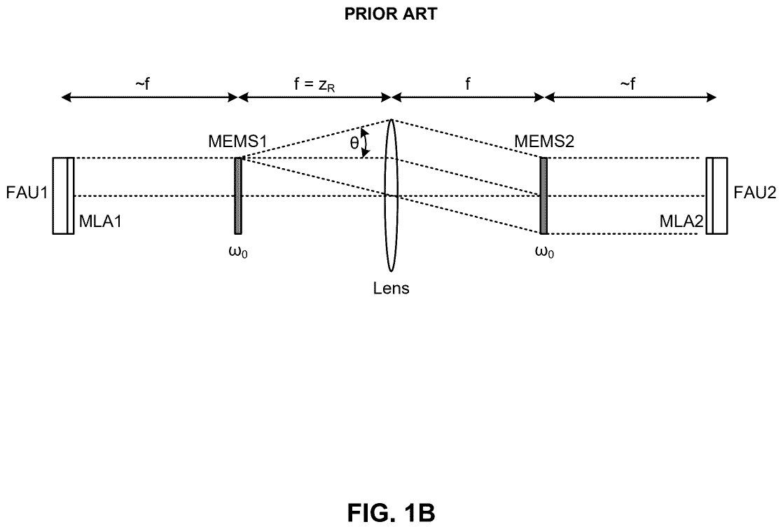

A conventional configuration for a high port count optical switch (e.g., an optical cross-connect switch (OXC)) is to direct parallel collimated optical beams at an array of tilting mirrors. FIG. 1A is a diagram illustrating a conventional configuration of a high port count optical switch in an unfolded arrangement. For visual clarity, tilting mirrors in mirror arrays MEMS1 and MEMS2 are shown in FIG. 1A as transmissive beam steering elements (so that optical paths can be shown without overlapping). As shown FIG. 1A, in the conventional optical switch, optical beams (indicated by dotted lines) are provided via a fiber array unit FAU1 and a microlens array MLA1. As illustrated in FIG. 1A, a topmost mirror t1 of the mirror array MEMS1 must be capable of steering a beam through an angle range from zero angle (to couple to a topmost mirror t2 on mirror array MEMS2) to −2θ (to couple to a bottommost mirror b2 on the mirror array MEMS2). Similarly, a bottommost mirror b1 on the mirror array MEMS1 should be capable of steering a beam through an angle from 0 (to couple to the bottommost mirror b2 on the mirror array MEMS2) to +2θ (to couple to the topmost mirror t2 on the mirror array MEMS2). Therefore, in the conventional optical switch, a total required beam steering range is 4θ.

One technique to reduce or minimize the beam steering requirements of tilting mirrors in a mirror array utilizes a lens between the two mirror arrays, an example of which is illustrated in FIG. 1B. In such a configuration, the lens allows optical beams incident on the mirror arrays to be parallel, meaning that the fiber array units (FAUs) and microlens arrays (MLAs) can be the same size as the mirror arrays, while achieving a total beam steering angle range of 2θ. However, the lens between the mirror arrays in such a configuration can be a source of cross-talk between configured ports of the optical switch. For example, small defects in an optical surface of the lens can scatter light from one beam path to another, meaning that cross-talk can be introduced, thereby degrading performance of the optical switch.

Notably, the annotations “f” and “ω₀” are used in FIGS. 1A and 1B. In the optical switch shown in FIG. 1B, a beam waist (e.g., a position where a size of an optical beam is the smallest) should be located at or close to a plane of the mirror array MEMS1 so that the size of each tilting mirror of the mirror array can be as small as possible (e.g., to simplify manufacturing of the mirror array MEMS1). Here, “ω₀” denotes a radius of the optical beam at the beam waist. If it is desired that the beam size and the mirror size on the mirror array MEMS2 be the same as that on the mirror array MEMS1, then a focal length of the lens should be equal to the Rayleigh range of the optical beam (assuming the optical beam is a Gaussian beam). The Rayleigh range

$$( {Z}_{R} = \frac{π {ω}_{0}^{2}}{λ} )$$

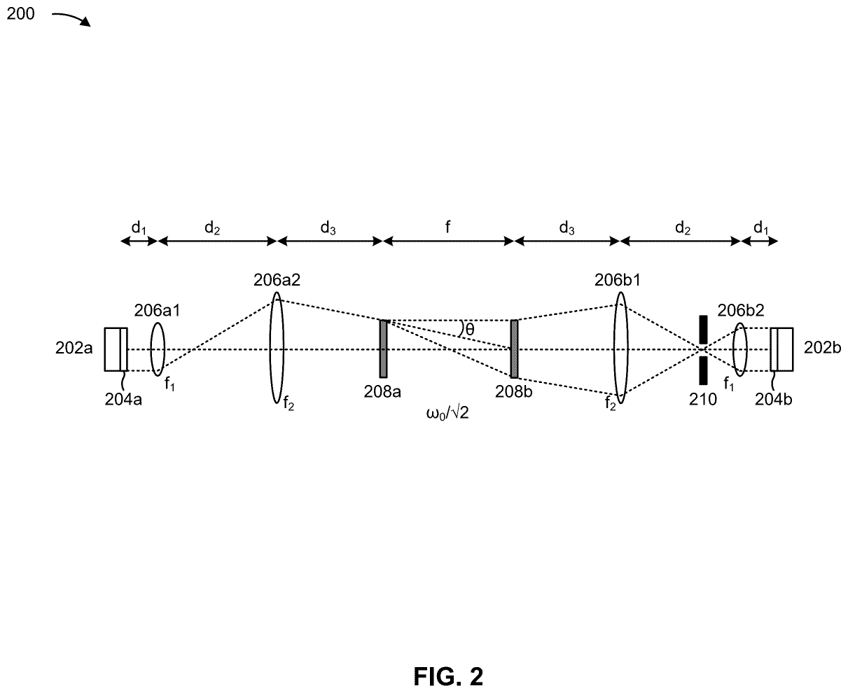

is a distance at which the beam size has increased to √2 larger than the size of the optical beam at the beam waist. In FIG. 1A, there is no lens, but the notations “f” and “ω₀” are present. In this case, it is assumed that tilting mirrors of the mirror arrays are of the same size as those in FIG. 1B. Therefore, if the same mirror array as used in FIG. 1B were to be used in the optical switch of FIG. 1A, then the beam waist should be located midway between the two mirror arrays and should have a waist size that is √2 smaller than the beam waist size in FIG. 1B, so that after propagating to the mirrors of the mirror arrays, the beam size is the same as in FIG. 1B. For a given mirror size in the conventional optical switch of FIG. 1A, the largest separation between the mirror array MEMS1 and the mirror array MEMS2 is obtained when the condition above is met (i.e., when the mirror arrays are located one Rayleigh range from the beam waist). This leads to the separation between the mirror array MEMS1 and the mirror array MEMS2 in FIG. 1A being equal to f—the focal length of the lens in FIG. 1B. Thus, the notation “f” in FIG. 1A is referring to the separation between the mirror array MEMS1 and the mirror array MEMS2, assuming that the same mirror array is being used as that used in FIG. 1B. The annotations “f” and “ω₀” are similarly used in the example implementations shown and described below with respect to FIGS. 2-5.

Some implementations described herein provide an optical switch comprising an array of optical ports (e.g., a fiber array unit (FAU)), an array of beam-forming elements (e.g., a microlens array (MLA)) optically coupled to the array of optical ports, and an array of beam steering elements (e.g., an array of micro-electromechanical systems (MEMS) mirrors) optically coupled to the array of beam-forming elements. The optical switch further includes a set of optical elements in a region of optical coupling between the array of beam-forming elements and the array of beam steering elements. In some implementations, the set of optical elements is to cause a size of a projected beam-array field at a plane of the array of beam-forming elements to be larger than a size of the array of beam-forming elements. In operation, the set of optical elements arranged in the region of optical coupling between the array of beam-forming elements and the array of beam steering elements may cause optical beams from a smaller sized array of beam-forming elements (and a smaller sized array of optical ports) to be directed onto the array of beam steering elements with a beam spacing that matches a pitch between beam steering elements in the array of beam steering elements, and with appropriate beam angles such that beam steering requirements of the array of beam steering elements is minimized. That is, the optical switch described herein reduces a beam steering angle requirement of the array of beam steering elements (e.g., relative to those in FIG. 1A) and without inserting a lens between the arrays of beam steering elements, thereby avoiding the introduction of cross-talk (e.g., as in FIG. 1B). Further, in some implementations, the optical switch described herein enables beam steering requirements of the array of beam steering elements to be minimized without increasing a size of an array of optical ports or an array of beam-forming elements of the optical switch. Additional details are provided below.

FIG. 2 is a diagram illustrating an example implementation of an optical switch 200 that achieves a reduced beam steering angle requirement and a reduced optical port array and beam-forming element array size, without introducing cross-talk. As shown in FIG. 2, in one example implementation, the optical switch 200 comprises a first array of optical ports 202a, a first array of beam-forming elements 204a, a first set of optical elements 206a (e.g., including an optical element 206a1 and an optical element 106 206a2), a first array of beam steering elements 208a, a second array of beam steering elements 208b, a second set of optical elements 206b (e.g., including an optical element 206b1 and an optical element 206b2), a second array of beam-forming elements 204b, and a second array of optical ports 202b. As further shown, the optical switch 200 may in some implementations optionally include an aperture element 210. Elements of the optical switch 200 are described below, followed by an example of operation of the optical switch 200.

An array of optical ports 202 is a fiber array to couple optical beams to the optical switch 200 or to couple beams from the optical switch 200. For example, in some implementations, the first array of optical ports 202a may be an input FAU that couples optical beams to the optical switch 200 (e.g., from a set of input optical fibers), while the second array of optical ports 202b may be an output FAU that couples optical beams out of the optical switch 200 (e.g., to a set of output optical fibers). In such an implementation, the first array of optical ports 202a provides the set of optical beams to the first array of beam-forming elements 204a and the second array of optical ports 202b receives the set of optical beams after collimation by the second array of beam-forming elements 204b (e.g., the optical beams propagate in left-to-right with respect to FIG. 2). In some implementations, an array of optical ports 202 (e.g., the first array of optical ports 202a, the second array of optical ports 202b) may comprise a one-dimensional (1D) array or may comprise a two-dimensional (2D) array. In some implementations, an array of optical ports 202 is optically coupled to an array of beam-forming elements 204 (e.g., the first array of optical ports 202a is optically coupled to the first array of beam-forming elements 204a, the second array of optical ports 202b is optically coupled to the second array of beam-forming elements 204b).

An array of beam-forming elements 204 is array of elements to collimate the set of optical beams propagating through the optical switch 200. For example, the first array of beam-forming elements 204a may comprise a first MLA including an array of microlenses to collimate the set of optical beams provided by the first array of optical ports 202a, while the second array of beam-forming elements 204b may comprise a second MLA including an array of microlenses to collimate the set of optical beams to be provided to the second array of optical ports 202b (e.g., after direction by the second array of beam steering elements 208b). In some implementations, the spacing and arrangement of beam-forming elements in the first array of beam-forming elements 204a matches a spacing and arrangement of optical ports in the first array of optical ports 202a (e.g., such that each optical port in the first array of optical ports 202a provides light to a respective beam-forming element in the first array of beam-forming elements 204a on a one-to-one basis). Similarly, the spacing and arrangement of beam-forming elements in the second array of beam-forming elements 204b may match a spacing and arrangement of optical ports in the second array of optical ports 202b (e.g., such that each optical port in the second array of optical ports 202b receives light from a respective beam-forming element in the second array of beam-forming elements 204b on a one-to-one basis). In some implementations, an array of beam-forming elements 204 is optically coupled to an array of beam steering elements 208 (e.g., the first array of beam-forming elements 204a a is optically coupled to the first array of beam steering elements 208a, the second array of beam-forming elements 204b is optically coupled to the second array of beam steering elements 208b).

A set of optical elements 206 comprises one or more optical elements to modify a size or a spacing of the set of optical beams propagating through the optical switch 200. For example, the first set of optical elements 206a (e.g., the optical element 206a1 and the optical element 206a2) may comprise a first set of lenses that serve to increase a size and spacing of the set of optical beams at the first array of beam steering elements 208a (relative to a size and spacing of the set of optical beams at the first array of beam-forming elements 204a). In some implementations, the increase in the size and the spacing provided by the first set of optical elements 206a causes a spacing between adjacent optical beams in the set of optical beams to match a pitch between adjacent beam steering elements of the first array of beam steering elements 208a. As another example, the second set of optical elements 206b (e.g., the optical element 206b1 and the optical element 206b2) may comprise a second set of lenses that serve to decrease the size and spacing of the set of optical beams at the second array of beam-forming elements 204b (relative to the size and spacing of the set of optical beams at the second array of beam steering elements 208b). In some implementations, the decrease in the size and the spacing by the second set of optical elements 206b causes the spacing between adjacent optical beams in the set of optical beams to match a pitch between adjacent beam-forming elements of the second array of beam-forming elements 204b.

Put another way, a set of optical elements 206 may comprise one or more optical elements to cause an area of a projected beam-array field at a plane of an array of beam-forming elements 204 to be larger than an area of an array of beam-forming elements 204. A projected beam-array field at a reference plane (e.g., a plane of an array of beam-forming elements 204) is determined by projecting beams in a set of optical beams back along their incident directions and determining a minimum convex region containing intersections of those projected optical beams with the reference plane. Additionally, the set of optical elements 206 may cause an area of a beam-array field at a plane of an array of beam steering elements 208 to be larger than an area corresponding to beam-forming elements in an array of beam-forming elements 204.

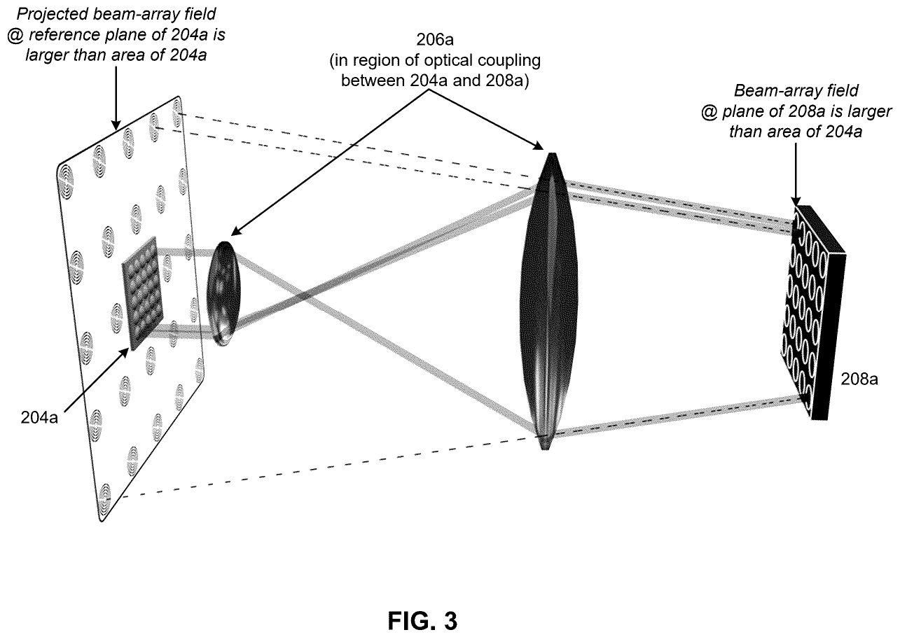

FIG. 3 is a diagram of an illustrative example of a projected beam-array field in the context of the optical switch 200. In FIG. 3, optical beams in a set of optical beams pass through the set of optical elements 206a (e.g., a pair of lenses) and are incident on the array of beam steering elements 208a at respective angles. Here, the projected beam-array field at a plane of the array of beam-forming elements 204a is determined by projecting these optical beams back along their incident directions to the plane of the array of beam-forming elements 204a. As illustrated in FIG. 3, an area of the projected beam-array field at the plane of the first array of beam-forming elements 204a is larger than an area of the first array of beam-forming elements 204a. Thus, in this example, the set of optical elements 206a cause an area of the projected beam-array field at the plane of the array of beam-forming elements 204a to be larger than an area of the array of beam-forming elements 204a. Notably, the projected beam-array field is a geometric construct for expressing the range of angles incident on an array of beam steering elements, and is not a tangible element with respect to operation or function of the optical switch 200. Additionally, as illustrated in FIG. 3, the set of optical elements 206 may cause an area of the beam-array field at a plane of the first array of beam steering elements 208a to be larger than an area corresponding to beam-forming elements in the first array of beam-forming elements 204a. The second set of optical elements 206b may cause a similar effect. That is, the second set of optical elements 206b may cause an area of a projected beam-array field at a plane of the second array of beam-forming elements 204b to be larger than an area of the second array of beam-forming elements 204b, and may cause an area of a beam-array field at a plane of the second array of beam steering elements 208b to be larger than an area corresponding to beam-forming elements in the second array of beam-forming elements 204b.

As indicated above, FIG. 3 is provided as an example. Other examples may differ from what is described with regard to FIG. 3.

Returning to FIG. 2, in some implementations, a set of optical elements 206 is in a region of optical coupling between an array of beam-forming elements 204 and an array of beam steering elements 208 (e.g., the first set of optical elements 206a is in a region of optical coupling between the first array of beam-forming elements 204a and the first array of beam steering elements 208a, the second set of optical elements 206b is in a region of optical coupling between the second array of beam-forming elements 204b and the second array of beam steering elements 208b). In some implementations, a given set of optical elements 206 may include one or more lenses (e.g., as shown in FIG. 2). Additionally, or alternatively, a given set of optical elements 206 may include one or more curved mirrors or another type of optical element capable of increasing or decreasing the size or spacing of the set of optical beams.

An array of beam steering elements 208 comprises an array of adjustable elements to direct (i.e., steer) the set of optical beams within the optical switch 200. For example, the first array of beam steering elements 208a may comprise an array of beam steering elements associated with directing each optical beam in the set of optical beams toward the second array of beam steering elements 208b. In some implementations, the first array of beam steering elements 208a comprises multiple independent beam steering elements to direct beams in the set of optical beams independently. Similarly, the second array of beam steering elements 208b may comprise multiple independent beam steering elements to direct the beams in the set of optical beams independently. That is, each of the first array of beam steering elements 208 and the second array of beam steering elements 208 may comprise multiple independent beam steering elements to direct beams in the set of optical beams independently. In some implementations, the first array of beam steering elements 208a is optically coupled to the second array of beam steering elements 208b.

In some implementations, an array of beam steering elements 208 (e.g., the first array of beam steering elements 208a, the second array of beam steering elements 208b) may comprise an array of tiltable MEMS mirrors, where each tiltable MEMS mirror can be used to direct one or more optical beams incident thereon. In some implementations, a size (e.g., a width, a height, or the like) of the first array of beam steering elements 208a is larger than a corresponding size of the first array of optical ports 202a (i.e., the size of the first array of optical ports 202a is smaller than the corresponding size of the first array of beam steering elements 208a). Similarly, in some implementations, a size (e.g., a width, a height, or the like) of the second array of beam steering elements 208b is larger than a corresponding size of the second array of optical ports 202b (i.e., the size of the second array of optical ports 202b is smaller than the corresponding size of the second array of beam steering elements 208b). In some implementations, the use of comparatively smaller array of optical ports 202 is enabled due to the increase and decrease in the size and spacing of the optical beams provided by the sets of optical elements 206 described above.

The aperture element 210 is an optional element to reduce cross-talk between optical beams propagating through the optical switch 200. In some implementations, as shown in FIG. 2, the aperture element 210 may be arranged in a region of optical coupling between the second array of beam steering elements 208b and the second array of beam-forming elements 204b. In some implementations, the aperture element 210 may be arranged at a location at which all optical beams in the set of optical beams intersect. In this way, the aperture element 210 can reduce cross-talk between beam paths, particularly during switch reconfiguration operations. For example, during a switch reconfiguration operation, optical beams incident on intermediate, already-configured beam steering elements in the second array of beam steering elements 208b while beam steering elements in the first array of beam steering elements 208a are being reconfigured would be incident on the aperture element 210 at an off-axis location. These optical beams would therefore be blocked by the aperture element 210 (e.g., such that these optical beams are not incident on the second array of beam-forming elements 204b), meaning that cross-talk is avoided. In some implementations, a second aperture element 210 can be arranged in a region of optical coupling between the first array of beam-forming elements 204a and the first array of beam steering elements 208a, such as when the optical switch 200 is a bidirectional optical switch.

In an example operation of the optical switch 200, the first array of optical ports 202a provides a set of optical beams to the first array of beam-forming elements 204a. The first array of beam-forming elements 204a collimates the set of optical beams provided by the first array of optical ports 202a. After collimation of the set of optical beams by the first array of beam-forming elements 204a, the first set of optical elements 206a increases a size and a spacing of the set of optical beams at the first array of beam steering elements 208a (relative to a size and spacing of the set of optical beams at the first array of beam-forming elements). That is, the first set of optical elements 206a may cause an area of a projected beam-array field at a plane of the first array of beam-forming elements 204a to be larger than an area of the first array of beam-forming elements 204a. Further, the first set of optical elements 206a may cause an area of a beam-array field at a plane of the first array of beam steering elements 208a to be larger than an area corresponding to beam-forming elements in the first array of beam-forming elements 204a.

The first array of beam steering elements 208a then directs (e.g., based on a switching configuration) the set of optical beams. Here, each beam steering element in the first array of beam steering elements 208a directs an optical beam incident thereon toward a beam steering element in the second array of beam steering elements 208b. As noted above, each beam steering element in the first array of beam steering elements 208a directs the one or more beams incident thereon independently. In some implementations, a beam waist of a given optical beam in the set of optical beams is near a midpoint in a region of optical coupling between the first array of beam steering elements 208a and the second array of beam steering elements 208b. The second array of beam steering elements 208b further directs (e.g., based on the switching configuration) the set of optical beams after direction by the first array of beam steering elements 208a. Here, each beam steering element in the second array of beam steering elements 208b directs an optical beam incident thereon toward a beam-forming element in the second array of beam-forming elements 204b. As noted above, each beam steering element in the second array of beam steering elements 208b directs the one or more optical beams incident thereon independently. After direction by the second array of beam steering elements 208b, the second set of optical elements 206b decreases the size and the spacing of the set of optical beams at the second array of beam-forming elements 204b (relative to a size and spacing of the set of optical beams at the second array of beam steering elements 208b). The second array of beam-forming elements 204b then collimates the set of optical beams after the decrease in the size and the spacing by the second set of optical elements 206b, and the second array of optical ports 202b receives the set of optical beams after collimation by the second array of beam-forming elements 204b. Here, the second set of optical elements 206b may cause an area of a projected beam-array field at a plane of the second array of beam-forming elements 204b to be larger than an area of the second array of beam-forming elements 204b. Further, the second set of optical elements 206b may cause an area of a beam-array field at a plane of the second array of beam steering elements 208b to be larger than an area corresponding to beam-forming elements in the second array of beam-forming elements 204b.

In the above-described operation of the optical switch 200, the optical beams converge onto the first array of beam steering elements 208a so as to minimize a required beam steering angle. Further, the first set of optical elements 206 is used to increase a size of the optical beams in a region of optical coupling between the first array of optical ports 202a and the first array of beam steering elements 208a, which enables a reduced-size first array of optical ports 202a and a reduced-size first array of beam-forming elements 204a to be used, while also providing low beam steering angles. Further, there are no optical elements in a region of optical coupling between the first array of beam steering elements 208a and the second array of beam steering elements 208b, thereby avoiding cross-talk while achieving the benefits described above.

In some implementations, as noted above, the first set of optical elements 206a is arranged in a region of optical coupling between the first array of optical ports 202a and the first array of beam steering elements 208a (e.g., on the input side of the optical switch 200). As noted above, such a configuration serves to increase (on the input side) a beam size and spacing at the array of beam steering elements 208a (e.g., relative to a beam size and spacing at the first array of beam-forming elements 204a), meaning that a size (e.g., a width, a height) of the first array of optical ports 202a and a size of the first array of beam-forming elements 204a can be reduced such that a size of the first array of optical ports 202a and the first array of beam-forming elements 204a is smaller than a corresponding size of the first array of beam steering elements 208a. Similarly, the second set of optical elements 206b is arranged in a region of optical coupling between the second array of beam steering elements 208b and the second array of optical ports 202b (e.g., on the output side of the optical switch 200). As noted above, such a configuration serves to decrease (on the output side) the beam size and spacing at the second array of beam-forming elements 204b (e.g., relative to a beam size and spacing at the second array of beam steering elements 208b), meaning that a size (e.g., a width, a height) of the second array of optical ports 202b and a size of the second array of beam-forming elements 204b can be reduced such that a size of the second array of optical ports 202b and the second array of beam-forming elements 204b a is smaller than a corresponding size of the second array of beam steering elements 208b. Additionally, the set of optical elements 206a provides angles to the optical beams on the array of beam steering elements 208a, meaning that a beam steering angle requirement of the array of beam steering elements 208a is reduced.

One advantage of the configuration of the optical switch 200 shown in FIG. 2 is that such a configuration reduces a beam steering requirement of the array of beam steering elements 208 (e.g., a total beam steering angle of 2θ needed, as compared to 4θ). In some implementations, the beam steering requirement for a given array of beam steering elements 208 is approximately equal to one-half of a size of the given array of beam steering elements 208 divided by a distance between the first array of beam steering elements 208a and the second array of beam steering elements 208b. Put another way, the beam steering requirement may be such that, at a rest position (e.g., when a 0 volt (V) control voltage is applied to the beam steering elements of a given array of beam steering elements 208), each beam steering element is to direct a respective optical beam to approximately a same location on the other array of beam steering elements 208. Another advantage of the configuration of the optical switch 200 shown in FIG. 2 is that such a configuration does not require any optical elements in a region of optical coupling between the first array of beam steering elements 208a and the second array of beam steering elements 208b. Therefore, cross-talk between optical beam paths is avoided.

In some implementations, the quantity of adjustable parameters associated with the optical switch 200 is greater than the quantity of constraints, which provides flexibility in the design of the optical switch 200 to achieve a desired property. For example, as illustrated in FIG. 2, the optical switch 200 may have five parameters that can be varied to achieve the functionality described above: a focal length f₁ (e.g., a focal length of the optical element 206a1, a focal length of the optical element 206b2), a focal length f₂ (e.g., a focal length of the optical element 206a2, a focal length of the optical element 206b1), a distance d₁ (e.g., a distance between the first array of beam-forming elements 204a and the optical element 206a1, a distance between the optical element 206b2 and the second array of beam-forming elements 204b), a distance d₂ (e.g., a distance between the optical element 206a1 and the optical element 206a2, a distance between the optical element 206b1 and the optical element 206b2), and a distance d₃ (e.g., a distance between the optical element 206a2 and the first array of beam steering elements 208a, a distance between the second array of beam steering elements 208b and the optical element 206b1). The constraints would include the position and angle of the beam at the beam steering element 208a and the size and location of the beam waist. Here, because there are more adjustable parameters than there are constraints, and there is at least one free parameter. For example, the distance d₃ can be fixed so that the optical element 206a2 is at a preferable or convenient distance from the first array of beam steering elements 208a (and such that the optical element 206b1 is at a preferable or convenient distance from the second array of beam steering elements 208b), and the remaining parameters can be optimized to obtain a set of desired properties.

As indicated above, FIG. 2 is provided as an example. Other examples may differ from what is described with regard to FIG. 2. The number and arrangement of elements shown in FIG. 2 are provided as an example. In practice, there may be additional elements, fewer elements, different elements, or differently arranged elements than those shown in FIG. 2. Furthermore, two or more elements shown in FIG. 2 may be implemented within a single element, or a single element shown in FIG. 2 may be implemented as multiple, distributed elements. Additionally, or alternatively, a set of elements (e.g., one or more elements) shown in FIG. 2 may perform one or more functions described as being performed by another set of elements shown in FIG. 2.

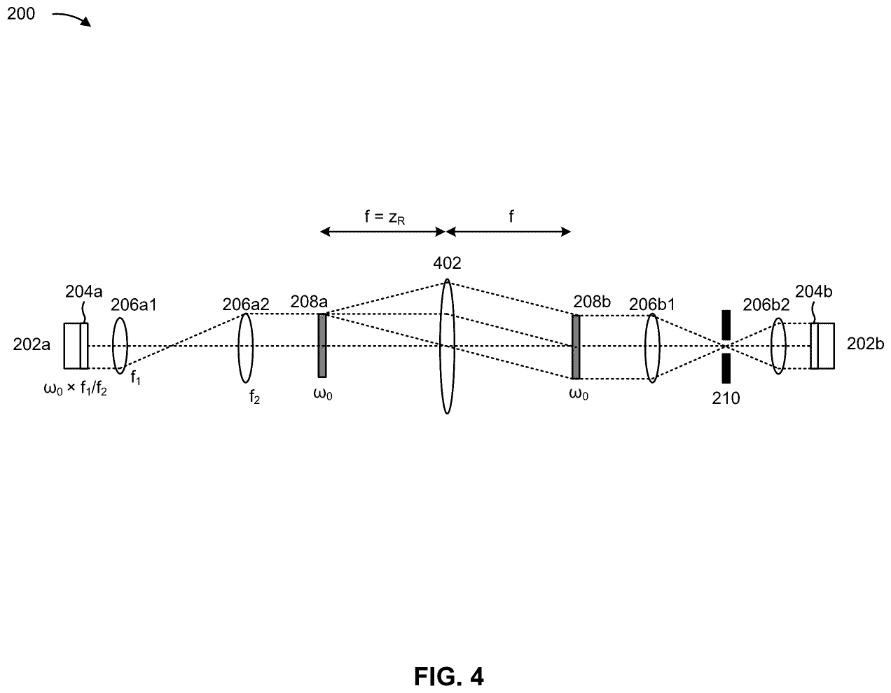

FIG. 4 is a diagram illustrating an example implementation of an optical switch 200 that achieves a reduced beam steering angle requirement and a reduced optical port array and beam-forming element array size. As shown in FIG. 4, the optical switch 200 may in some implementations include an optical element 402 in a region of optical coupling between the first array of beam steering elements 208a and the second array of beam steering elements 208b. The optical element 302 may be, for example, a lens (e.g., a Fourier lens). Notably, the configuration of the optical switch 200 shown in FIG. 4 differs from the configuration of the optical switch 200 shown in FIG. 2 in that the optical beams incident on the first array of beam steering elements 208a are parallel, and beam waists are located at the arrays of beam steering elements 208. Thus, optimization conditions for the sets of optical elements 206 in the configuration shown in FIG. 4 are different from those for the configuration shown in FIG. 2.

One solution is that magnification provided by the first set of optical elements 206a in a region of optical coupling between the first array of optical ports 202a and the first array of beam steering elements 208a is equal to f₁/f₂, a distance between the first array of optical ports 202a and the optical element 206a1 is equal to f₁, a distance between the optical element 206a1 and the optical element 206a2 is equal to f₁+f₂, and a distance between the optical element 206a2 lens and the first array of beam steering elements 208a is equal to f₂, where f₁ and f₂ are the focal lengths of the optical element 206a1 and the optical element 206a2, respectively. Such a configuration is advantageous in that any fiber position errors in the array of optical ports 202a (which result in beam angle errors after being collimated by the first array of beam-forming elements 204a) can be corrected by adjusting the corresponding beam steering element angles, which can be done during calibration of the optical switch 200. Further, the configuration of the optical switch in FIG. 4 achieves low insertion loss because the first array of beam steering elements 208a aperture is located at an image of the first array of beam-forming elements 204a aperture, meaning that there will be no additional light lost to beam clipping at the first array of beam steering elements 208a, after an optical beam has been clipped by the first array of beam-forming elements 204a aperture. In some implementations, the configuration of the optical switch 200 including the optical element 402 can be used, when for example, a risk of cross-talk is acceptable or cross-talk can be otherwise controlled or eliminated.

As indicated above, FIG. 4 is provided as an example. Other examples may differ from what is described with regard to FIG. 4. The number and arrangement of elements shown in FIG. 4 are provided as an example. In practice, there may be additional elements, fewer elements, different elements, or differently arranged elements than those shown in FIG. 4. Furthermore, two or more elements shown in FIG. 4 may be implemented within a single element, or a single element shown in FIG. 4 may be implemented as multiple, distributed elements. Additionally, or alternatively, a set of elements (e.g., one or more elements) shown in FIG. 4 may perform one or more functions described as being performed by another set of elements shown in FIG. 4.

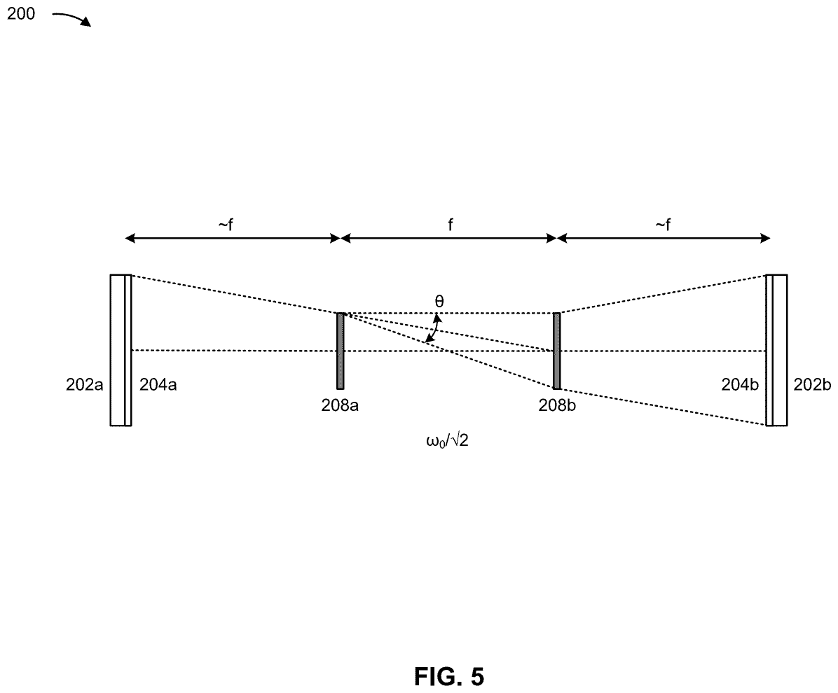

FIG. 5 is a diagram illustrating an example implementation of an optical switch 200 that achieves a reduced beam steering angle requirement. An alternative technique to reduce a beam steering angle requirement of the array of beam steering elements 208 is to direct optical beams incident on the first array of beam steering elements 208 such that, at zero steering angle, each optical beam is directed to a center beam steering element on the second array of beam steering elements 208. FIG. 5 is a diagram illustrating such a configuration of the optical switch 200.

In this configuration, input optical beams are incident on the first array of beam steering elements 208a at an angle such that, if beam steering element of the array of beam steering elements 208a is at rest (e.g., has zero tilt), then an optical beam incident thereon is directed to a center beam steering element of the array of beam steering elements 208b. In such an implementation, to direct an optical beam to a topmost beam steering element on the second array of beam steering elements 208b, a beam steering element of the first array of beam steering elements 208 may need to steer the optical beam by an angle corresponding to +θ. Similarly, to steer the optical beam to the bottommost beam steering element on the array of beam steering elements 208b, the beam steering element may need to steer the optical beam by an angle corresponding to −θ. This condition holds for each beam steering element on the first array of beam steering elements 208a, and so the total beam steering angle is 2θ. Such a configuration is advantageous in that a quantity of elements in the optical switch is reduced, which may reduce cost of the optical switch 200 or complexity of assembly of the optical switch 200. Notably, however, the array of optical ports 202 and the array of beam-forming elements 204 in such a configuration need to be sized appropriately (e.g., the size of the array of optical ports 202 and the array of beam-forming elements 204 may need to be increased).

As indicated above, FIG. 5 is provided as an example. Other examples may differ from what is described with regard to FIG. 5. The number and arrangement of elements shown in FIG. 5 are provided as an example. In practice, there may be additional elements, fewer elements, different elements, or differently arranged elements than those shown in FIG. 5. Furthermore, two or more elements shown in FIG. 5 may be implemented within a single element, or a single element shown in FIG. 5 may be implemented as multiple, distributed elements. Additionally, or alternatively, a set of elements (e.g., one or more elements) shown in FIG. 5 may perform one or more functions described as being performed by another set of elements shown in FIG. 5.

Notably, for clarity, FIGS. 2-5 depict an optical axis of the optical switch 200 in a linear, unfolded orientation. In a physical implementation, any one or more of the elements along the optical path of the optical switch 200 may be configured to deflect or reflect the optical path to fold or multiply-fold the optical path of the optical switch 200. Such an implementation can be used to decrease an actual size or dimension of the optical switch 200 and/or can result in some physical overlap of the cited “regions” of the optical switch 200. However, the linear description provided in association with FIGS. 2-5 and the functional roles of the separate regions of the optical switch 200 herein would maintain their nature even in the presence of such optical folding and/or overlap. Thus, the first array of beam steering elements 208a and/or the second array of beam steering elements 208b may in some implementations comprise an array of reflective beam steering elements. In one example, both the first array of beam steering elements 208a and the second array of beam steering elements 208b are arrays of reflective beam steering elements (e.g., such that a z-shaped optical path is formed in the optical switch 200). Similarly, in some implementations, one or more optical elements of the first set of optical elements 206a (e.g., one or more optical elements in the region of optical coupling between the first array of beam-forming elements 204a and the first array of beam steering elements 208a) may be reflective optical elements and/or one or more optical elements of the second set of optical elements 206b (e.g., one or more optical elements in the region of optical coupling between the second array of beam steering elements 208b and the second array of beam-forming elements 204b) may be reflective optical elements. Such an implementation may be used, for example, to further fold the optical path of the optical switch 200 (e.g., to reduce or control a physical size or dimension of the optical switch 200).

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When an element or one or more elements (e.g., an optical element, one or more optical elements, or a set of optical elements) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first element” and “second element” or other language that differentiates elements in the claims), this language is intended to cover a single element performing or being configured to perform all of the operations, a group of elements collectively performing or being configured to perform all of the operations, a first element performing or being configured to perform a first operation and a second element performing or being configured to perform a second operation, or any combination of elements performing or being configured to perform the operations. For example, when a claim has the form “one or more elements configured to: perform X; perform Y; and perform Z,” that claim should be interpreted to mean “one or more elements configured to perform X; one or more (possibly different) elements configured to perform Y; and one or more (also possibly different) elements configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical switch, comprising:
a first array of optical ports;
a first array of beam-forming elements, wherein the first array of optical ports is optically coupled to the first array of beam-forming elements;
a first array of beam steering elements, wherein the first array of beam-forming elements is optically coupled to the first array of beam steering elements;
a first set of optical elements to cause an area of a projected beam-array field at a plane of the first array of beam-forming elements to be larger than an area of the first array of beam-forming elements,
wherein the first set of optical elements is in a region of optical coupling between the first array of beam-forming elements and the first array of beam steering elements;
a second array of beam steering elements, wherein the first array of beam steering elements is optically coupled to the second array of beam steering elements;
a second array of beam-forming elements, wherein the second array of beam steering elements is optically coupled to the second array of beam-forming elements; and
a second array of optical ports, wherein the second array of beam-forming elements is optically coupled to the second array of optical ports.

2. The optical switch of claim 1, wherein an area of a beam-array field at a plane of the first array of beam steering elements is larger than an area corresponding to beam-forming elements in the first array of beam-forming elements.

3. The optical switch of claim 1, wherein the first set of optical elements provides a beam spacing that matches a pitch between adjacent beam steering elements of the first array of beam steering elements.

4. The optical switch of claim 1, further comprising a second set of optical elements to cause an area of a projected beam-array field at a plane of the second array of beam-forming elements to be larger than an area of the second array of beam-forming elements, wherein the second set of optical elements is in a region of optical coupling between the second array of beam steering elements and the second array of beam-forming elements.

5. The optical switch of claim 4, wherein an area of a beam-array field at a plane of the second array of beam steering elements is larger than an area corresponding to beam-forming elements in the second array of beam-forming elements.

6. The optical switch of claim 4, wherein the second set of optical elements provides a beam spacing that matches a pitch between adjacent beam-forming elements of the second array of beam-forming elements.

7. The optical switch of claim 1, wherein a beam steering requirement associated with the first array of beam steering elements is approximately equal to one-half of a size of the second array of beam steering elements divided by a distance between the first array of beam steering elements and the second array of beam steering elements.

8. The optical switch of claim 1, wherein, at a rest position, each beam steering element of the first array of beam steering elements is to direct a respective optical beam to approximately a same location on the second array of beam steer elements.

9. The optical switch of claim 1, wherein a beam waist of a given optical beam propagating in the optical switch is near a midpoint between the first array of beam steering elements and the second array of beam steering elements.

10. The optical switch of claim 1, wherein a size of the first array of beam-forming elements is smaller than a corresponding size of the first array of beam steering elements.

11. The optical switch of claim 1, further comprising an aperture element in a region of optical coupling between the second array of beam steering elements and the second array of beam-forming elements.

12. The optical switch of claim 1, further comprising a Fourier lens in a region of optical coupling between the first array of beam steering elements and the second array of beam steering elements, wherein a beam steering requirement associated with the first array of beam steering elements is approximately equal to one-half of a size of the second array of beam steering elements divided by a focal length of the Fourier lens.

13. The optical switch of claim 12, wherein a beam waist of a given optical beam propagating in the optical switch is at approximately the first array of beam steering elements and at approximately the second array of beam steering elements.

14. The optical switch of claim 1, wherein the first array of beam steering elements and the second array of beam steering elements each comprise multiple independent beam steering elements to direct optical beams independently.

15. The optical switch of claim 1, wherein at least one of the first array of beam steering elements or the second array of beam steering elements is an array of reflective beam steering elements.

16. The optical switch of claim 1, wherein at least one optical element of the first set of optical elements in the region of optical coupling between the first array of beam-forming elements and the first array of beam steering elements is a reflective optical element.

17. An optical switch, comprising:
a first set of optical elements to cause an area of a projected beam-array field at a plane of a first array of beam-forming elements of the optical device to be larger than an area of the first array of beam-forming elements,
wherein the first set of optical elements is in a region of optical coupling between the first array of beam-forming elements and a first array of beam steering elements of the optical device; and
a second set of optical elements to cause an area of a projected beam-array field at a plane of a second array of beam-forming elements of the optical device to be larger than an area of the second array of beam-forming elements,
wherein the second set of optical elements is in a region of optical coupling between a second array of beam steering elements of the optical device and the second array of beam-forming elements.

18. The optical switch of claim 17, wherein an area of a beam-array field at a plane of the first array of beam steering elements is larger than an area corresponding to beam-forming elements in the first array of beam-forming elements.

19. The optical switch of claim 17, wherein an area of a beam-array field at a plane of the second array of beam steering elements is larger than an area corresponding to beam-forming elements in the second array of beam-forming elements.

20. An optical device, comprising:
an array of optical ports;
an array of beam-forming elements optically coupled to the array of optical ports;
an array of beam steering elements optically coupled to the array of beam-forming elements; and
a set of optical elements to cause a size of a projected beam-array field at a plane of the array of beam-forming elements to be larger than a size of the array of beam-forming elements,
wherein the set of optical elements is in a region of optical coupling between the array of beam-forming elements and the array of beam steering elements.
